(19) United States
(12) Patent Application Publication
(10) Pub. No.: US 2017/0130692 A1
(43) Pub. Date: May 11, 2017

(54) Gravity Pneumatic Buoyant Powered Wheel Generator

(71) Applicants: Ray O. Chaney, Sidney, OH (US); Charles Chaney, Louisville, KY (US)

(72) Inventors: Ray O. Chaney, Sidney, OH (US); Charles Chaney, Louisville, KY (US)

(21) Appl. No.: 14/934,910

(22) Filed: Nov. 6, 2015

(51) Int. Cl. F03B 17/04

(52) U.S. Cl. CPC F03B 17/04; Y10S 415/916

(57) ABSTRACT

A gravitation pneumatic buoyant powered generation system includes a plurality of tanks and valve doors which controllably provide float balls to a drive mechanism which through buoyant force turns a drive shaft and operates a generator.

### FIELD OF THE INVENTION

The present invention relates to a power generation system, particularly to a gravitation pneumatic buoyant powered generation system.

### BACKGROUND OF THE INVENTION

There are many water based energy producing systems. These typically empty turbines and use the forces of flowing water to drive the turbine and generate energy.

Conventional coal and nuclear power plants generate carbon dioxide which are a problem for the environment. Therefore, much attention is paid to the green energy systems, such as the wind power generation system, hydroelectric power generation system and solar power generation system.

The green energies are environment-friendly and sustainable. There remains a desire to search for novel green energy sources and to this end the instant invention provides a gravity, pneumatic, buoyant powered wheel generator.

### SUMMARY OF THE INVENTION

It is an object to provide a green energy system.

It is another object to provide a gravitation pneumatic buoyant powered generation, wherein potential energy is converted into kinetic energy to drive a generator to generate electric power when float balls are moved upward from a low position to a high position by buoyant forces. A vertical water tank is provided in which the float balls move back to the high position from the low position to perform a cyclic operation and drive a generator.

Accordingly, the invention provides a gravitation pneumatic buoyant powered generation system. The gravity pneumatic buoyant aided wheel power generator includes a first vertical tank receiving float balls therein which fall downward due to gravity. A first check valve door is provided which opens under a vacuum to receive the float balls therethrough. An intermediate chamber is provided for receiving the float ball from the first vertical tank through the first check valve door.

A pneumatic device is communicably connected to the intermediate chamber to cause a pressure differential in the intermediate chamber thereby causing opening and closing of the first check valve door and intake of the float ball upon a negative pressure being applied. A second vertical water tank is communicably connected to the intermediate chamber by way of a second check valve door which is normally closed and opens upon a positive pressure being applied to the intermediate chamber by the pneumatic device thereby releasing the float ball into the second vertical water tank in a manner to rise and engage a fin on a side of a drive wheel which includes a central drive shaft. Positive pressure also closes the first check valve door. The drive wheel has a plurality of outwardly disposed fins each spaced and configured for receiving one float ball and by virtue of air within the float ball impinge force on an adjacent fin causing a rotational drive force on the wheel and in turn rotation of the drive shaft.

An end of the drive shaft can be splined to a gear mechanism which can include an adjustable crank to increase or decrease stroke of a connecting rod. A bellows or piston connects to the connecting rod for generating the pressure differential in the intermediate chamber. Another end of the drive shaft can be operatively connected to a generator which produces an electrical output upon movement of the drive wheel.

### BRIEF DESCRIPTION OF THE DRAWINGS

FIG. 1 is an end diagram schematically showing a gravitation pneumatic buoyant powered generation system according to the present invention; and FIG. 2 is a side view diagram schematically showing a gravitation pneumatic buoyant powered generation system according to the present invention.

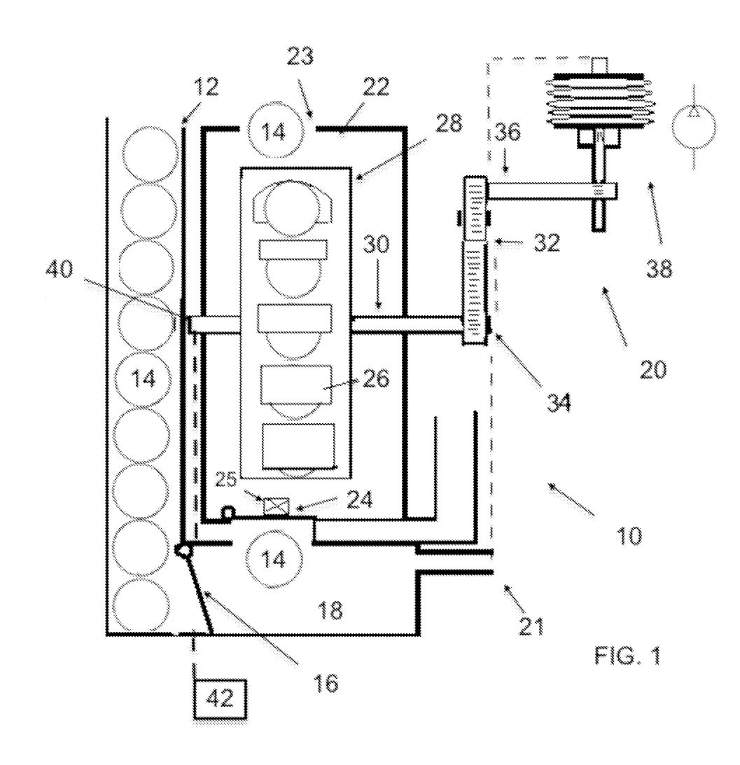

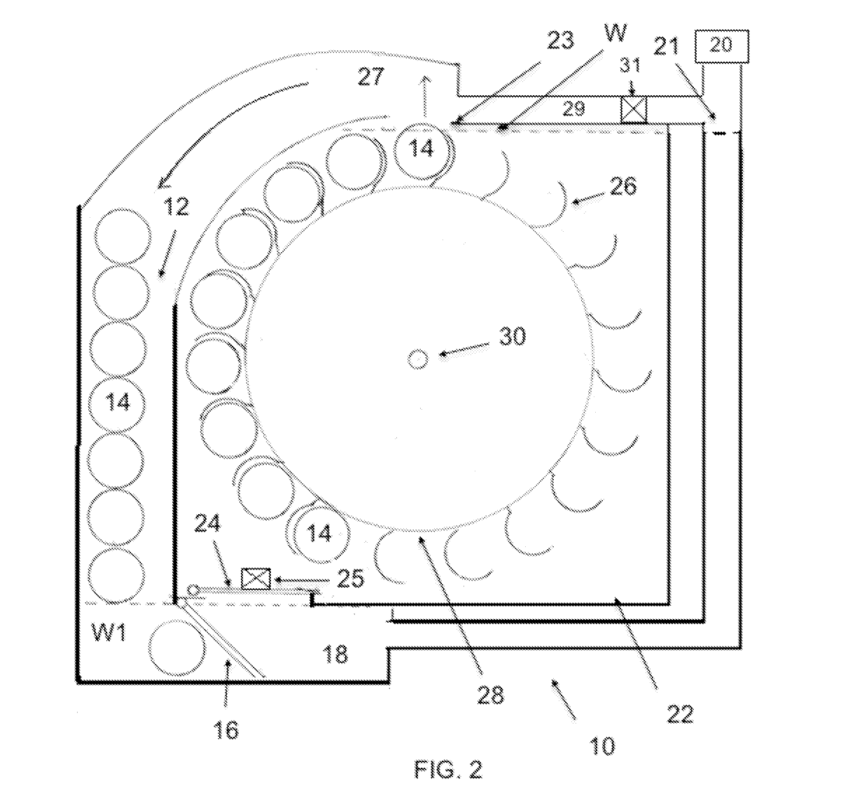

### DETAILED DESCRIPTION OF THE PREFERRED EMBODIMENTS

Referring now to the drawings, the gravitation pneumatic buoyant powered generation system of the present invention is generally designated by the numeral 10. The gravitation pneumatic buoyant powered generation system 10 provides for potential energy to be converted into kinetic energy to drive a generator to generate electric power when float balls 14 are moved upward from a low position to a high position by buoyant force. The float balls 14 move from the high position from the low position via gravity to perform a cyclic operation.

Accordingly, the gravity pneumatic buoyant aided wheel power generator includes a first vertical tank 12 receiving float balls 14 therein which fall downward due to gravity and superposed float balls 14. A check valve door 16 is provided which opens under a pressure differential (vacuum) to receive float balls 14 therethrough. An intermediate chamber 18 is provided for receiving the float balls 14 from the first vertical tank 12 through the check valve door 16.

A pneumatic device 20 is communicably connected to the intermediate chamber 18 to cause a pressure differential in the intermediate chamber 18 thereby causing opening and closing of the check valve door 16 and intake of one of the float balls 14 upon a negative pressure being applied. A second vertical water tank 22 is communicably connected to the intermediate chamber 18 by way of a second check valve door 24 which is normally closed and opens upon a positive pressure being applied to the intermediate chamber 18 by the pneumatic device 20 through and intake/exhaust line 21 thereby releasing the float ball 14 into the second vertical tank 22 in a manner to rise and engage one of the fins 26 on a side of a drive wheel 28. Second check valve door 24 can be equipped with a check valve device 25 to ease lift thereof. The drive wheel 28 includes a central drive shaft 30.

The plurality of fins 26 are outwardly disposed and are spaced and configured for receiving one of the float balls 14 as the rise and by virtue of air therein. The float balls 14 impinge force on the fins 26 causing a rotational drive force on the drive wheel 28 and in turn rotate the drive shaft 30.

An end 34 of the drive shaft 30 is splined to a gear mechanism 32 which can include an adjustable crank can be employed to increase or decrease stroke of a connecting rod 36. A bellows or piston 38 connects to the connecting rod 36 for generating the pressure differential in the intermediate chamber 18 and collectively functions as the pneumatic device 20. Another end 40 of the drive shaft 30 operatively connects to a generator 42 which produces an electrical output upon movement of the drive wheel 28.

When the float balls 14 engage the fins 26 the drive wheel 28 rotates clockwise. The generator 42 in turn generates electric power for use or storage. There can be employed a speed-change gear assembly which can increase the rotational speed to enhance the efficiency of power generation. Water levels are depicted by the letter W and W1.

As the specific gravity of the float balls 14 is smaller than that of water, the float balls 14 float and rise to an opening 23 of the vertical water tank 22 spontaneously. There is a chute 27 which feeds float balls 14 to the vertical tank 12. There is a bleed back line 29 connecting the line 21 and the chute 27 with a operably disposed check valve 31 for fluid level return. The water level W1 is able to maintained by virtue of the valve door 16 and thus enable drawing in the float ball 14 under pressure of the pneumatic device 38. Then, the float balls 14 are moved from the low position to the high position once again. The present invention can thus cyclically generate electric power by utilizing buoyant force.

An automated water supply device (not shown) can be is installed at the opening of the vertical water tank 22 and used to control the water level. A rotary control device (not shown) can also be provided in the chute 27, for example, to control the number of the float balls 14 delivered and in turn drive the driving wheel 28 to rotate at a constant speed. Thus, stable power output is provided to drive the generator 42 to generate electric power.

The present invention provides a low cost energy producer. It will be understood by those skilled in the art that modifications, derivations and improvements will be apparent to the claims herewith and should be included within the scope of the claims.

What is claimed is:

1. A gravitation pneumatic buoyant powered generation system, wherein potential energy is converted into kinetic energy to drive a generator to generate electric power when float balls are moved downward from a high position to a low position by gravity, which includes a vertical water tank having a drive wheel provided therein through which the float balls to move back to the high position from the low position through buoyant force to perform a cyclic operation and drive a generator, wherein the gravity pneumatic buoyant aided wheel power generator includes a first vertical tank receiving float balls therein which fall downward due to gravity and superposed float balls; a first check valve door communicably connected to said first vertical tank which opens under a vacuum to receive one of the float balls therethrough; an intermediate chamber communicably connected to said first vertical tank for receiving said float balls from said first vertical tank through said check valve door; a pneumatic device communicably connected to said intermediate chamber to cause a pressure differential in said intermediate chamber thereby causing opening and closing of said first check valve door and intake of said float ball upon a negative pressure being applied; a second vertical water tank communicably connected to said intermediate chamber by way of a second check valve door which is normally closed and opens upon a positive pressure being applied to said intermediate chamber by said pneumatic device thereby releasing one of said float balls into said second vertical tank, a drive wheel operably disposed in said second vertical water tank and said drive wheel has a central drive shaft, said drive wheel having a plurality of outwardly disposed fins each spaced and configured for receiving one float ball and when said float balls enter said second vertical water tank said float balls rise in a manner to engage one fin and by virtue of air within said float ball impinges force on said fin causing a rotational drive force on said drive wheel and in turn rotation of said drive shaft; and a generator operably connected to said drive shaft.

2. The gravitation pneumatic buoyant powered generation system of claim 1, wherein an end of said drive shaft is splined to a gear mechanism.

3. The gravitation pneumatic buoyant powered generation system of claim 1, wherein said said pneumatic device includes a bellows.

4. The gravitation pneumatic buoyant powered generation system of claim 1, wherein said said pneumatic device includes an air pump.

5. The gravitation pneumatic buoyant powered generation system of claim 1, which includes a chute connecting said first vertical tank to said second vertical water tank. tank includes an automatic water supply device at the opening.

6. The gravitation pneumatic buoyant powered generation system of claim 1, wherein said second valve door includes a check valve connected thereto.
